(19) United States
(12) Patent Application Publication
(10) Pub. No.: US 2003/0200769 A1
(43) Pub. Date: Oct. 30, 2003

(54) Process for manufacturing optical fiber preforms

(75) Inventors: Jacques Jolly, Chatou (FR); Jean-Florent Campion, Honorine (FR); Virginie Herchuelz, Andresy (FR); Remi Fauche, Acheres (FR); Eric Tutin, Montigny Les Cormeilles (FR)

Correspondence Address: SUGHRUE MION, PLLC, Suite 800, 2100 Pennsylvania Avenue, N.W., Washington, DC, 20037-3213, US

(73) Assignee: ALCATEL

(21) Appl. No.: 10/420,783

(22) Filed: Apr. 23, 2003

(30) Foreign Application Priority Data
Apr. 29, 2002 (FR) 02 05 374

(51) Int. Cl. C03B 37/02

(52) U.S. Cl. 65/391; 65/427; 65/435

(57) ABSTRACT

The invention relates to the field of processes for manufacturing optical fiber preforms. This is a process for manufacturing optical fiber preforms that includes a step of drawing the preform with a draw ratio that remains constant for the same preform and may vary from one preform to another depending on their respective mean diameters so as to reduce the variation in mean diameter between preforms or else a process for manufacturing optical fiber preforms that includes a step of compressing the preform with a compression ratio that remains constant for the same preform and may vary from one preform to another depending on their respective mean diameter so as to reduce the variation in mean diameter between preforms.

### CROSS-REFERENCE TO RELATED APPLICATIONS

This application is based on French Patent Application No. 02 05 374 filed Apr. 29, 2002, the disclosure of which is hereby incorporated by reference thereto in its entirety, and the priority of which is hereby claimed under 35 U.S.C. § 119.

### BACKGROUND OF THE INVENTION

1. Field of the Invention

The invention relates to the field of processes for manufacturing optical fiber preforms. Optical fibers are then obtained from these preforms by fiberizing them. The invention may apply to various preform manufacturing processes, especially the OVPO (outside vapor phase oxidation), VAD (vapor axial deposition) processes and CVD (chemical vapor deposition) processes.

2. Description of the Prior Art

According to one prior art, the preforms obtained by one or other of these processes display a large variation in diameter between preforms, especially in the case of a CVD process. This results in several drawbacks during the fiberizing process. During the fiberizing process, the preform is partially introduced into a fiberizing furnace. A seal located around the preform is necessary in order to maintain sealing between the inside of the fiberizing furnace and the environment outside the fiberizing furnace. Insofar as the diameter variation between preforms is considerable, it is necessary to use several sets of seals of different diameter so as to cover the major part of the range of diameter variation between preforms. Furthermore, the greater the diameter variation between preforms, the more complicated the automatic control of the fiberizing process, especially as regards the adaptation of both the applied heating power and the fiberizing rate, this being particularly so during startup of the fiberizing process and at the end of the fiberizing process. Moreover, the matching-up of two preforms, in order to weld them together end to end before fiberizing, becomes more difficult as the diameter variation between preforms increases.

With the aim of reducing the abovementioned drawbacks, the invention proposes to modify the preform manufacturing process by the addition of one step. Said step may be added in parallel, that is to say it may be carried out simultaneously with another step and therefore does not extend the total duration of the manufacturing process. Said step is a drawing or compression step or else a drawing step followed or preceded by a compression step, with a draw and/or compression ratio that reduces the diameter variation between preforms. Thus, a single set of seals of the same diameter may become sufficient, thereby appreciably simplifying the preform fiberizing process. In addition, automatic control of the fiberizing process becomes easier. Each of these simplifications makes it possible to increase the productivity of the fiberizing process used. Moreover, the matching-up of two preforms to be welded end to end also becomes easier.

According to another prior art, disclosed in patent application EP1156018, it is known to use a step during which drawing and/or compression operations are carried out along a preform, the draw and/or compression ratios varying along the preform. This step makes it possible in particular to reduce the diameter variation along the same preform.

### SUMMARY OF THE INVENTION

According to the invention, what is provided is a process for manufacturing optical fiber preforms comprising a step of drawing the preform with a draw ratio that remains constant for the same preform and may vary from one preform to another depending on their respective mean diameter so as to reduce the variation in mean diameter between preforms.

According to the invention, what is also provided is a process for manufacturing optical fiber preforms comprising a step of compressing the preform with a compression ratio that remains constant for the same preform and may vary from one preform to another depending on their respective mean diameter so as to reduce the variation in mean diameter between preforms.

According to the invention, what is furthermore provided is a process for manufacturing optical fiber preforms comprising a step of drawing the preform followed or preceded by a step of compressing the preform, the draw and compression ratios of which differ from each other, so that the resulting draw or compression ratio for the preform is non-zero, each remain constant for the same preform and may vary from one preform to another depending on their respective mean diameter so as to reduce the variation in mean diameter between preforms.

The invention will be more clearly understood and other features and advantages will become apparent from the description below and from the appended drawings, given by way of example.

### BRIEF DESCRIPTION OF THE DRAWINGS

FIG. 1 shows schematically histograms demonstrating the reduction in the mean diameter variation between preforms by the use of the manufacturing process according to the invention.

FIG. 2 shows schematically curves obtained from the histograms of FIG. 1 by smoothing and demonstrating the reduction in the mean diameter variation between preforms by the use of the manufacturing process according to the invention.

### DETAILED DESCRIPTION OF THE PREFERRED EMBODIMENTS

The drawing step may consist, for example, in moving a heat source along a preform so as to heat a zone of the preform at a given instant. By applying drawing movements to the ends of the preform, the latter is drawn in the heated zone and its diameter decreases. Step by step, over time, the entire preform is thus drawn, with as consequence a reduction in its diameter. The heat source is, for example, a plasma torch or a flame torch. The compression step may be similar, but it is compression movements that are applied in order to compress the preform, the diameter of which therefore increases.

In the case, for example, of a CVD process with a surfacing step, that includes in succession a step of preheating a primary preform, a step of depositing a surfacing layer around the primary preform, so as to obtain a final preform, and a warm glazing step for cleaning the surface of the final preform, the drawing step or compression step may be carried out, for example, either in parallel during the preheating step or in parallel during the start of the step of depositing the surfacing layer, this being most particularly beneficial in the case of small-diameter preforms, or during an additional step of very hot glazing, immediately preceding the glazing step for cleaning the surface, in the latter case the drawing or compression step not being carried out in parallel.

In other cases for example of preform manufacturing processes comprising a step for producing a primary preform followed by a step for producing a final preform from the primary preform, the drawing or compression step is preferably a drawing or compression step carried out on the primary preform, but it may also be a drawing or compression step carried out on the final preform. Correcting the diameter variation between preforms as soon as possible in the manufacturing process, while the diameter of the preforms is not yet too high, is more effective. If the preform manufacturing process includes a drawing step and a compression step, the two steps—drawing and compression—are preferably drawing and compression steps carried out on the primary preform.

Preferably, during the drawing step and/or during the compression step, the preform is in a horizontal position; however, said preform may be in a vertical position. The horizontal position is advantageous in that implementation and maintenance are thus made more practical. Given that the preform zone heated at any instant is not very extensive and that the material of the preform has a high viscosity, there is little risk of deformation, due to the effect of gravity, of the preform in a horizontal position, since the preform is being rotated during the heating.

In a first method of implementing the invention, the process for manufacturing optical fiber preforms includes a step of drawing the preform with a draw ratio which remains constant for the same preform and may vary from one preform to another depending on their respective mean diameters so as to reduce the mean diameter variation between preforms. The reduction in the diameter variation between preforms makes the preform fiberizing process advantageously uniform. The draw ratio chosen remains the same over the entire length of the preform. From one preform to another, the draw ratios chosen are different, insofar as the starting diameters of the respective preforms are different, that is to say two preforms in which one has a starting diameter, that is to say before the drawing step, but is higher than the starting diameter of the other one. The draw ratio for the preform having the larger starting diameter will be chosen to be higher than the draw ratio for the preform having the smaller starting diameter, so that the final diameters of the two preforms are preferably as close as possible to each other, or even practically identical, and in any case less different than the corresponding starting diameters. The final diameter, that is to say after drawing, of each preform is then less than or equal to its starting diameter. The constant draw ratio for a given preform, that depends on its starting diameter and depends on its intended final diameter, may be readily calculated automatically by the drawing device. Thus, the purpose of this drawing step with a constant draw ratio for the same preform is to achieve uniform drawing of each preform, the draw ratio varying from one preform to another depending on their starting diameter and being chosen so as to reduce the variation in the final diameters, that is to say after drawing, of said preforms. Since the diameter of a preform is not in general perfectly constant along the preform, the starting and final diameters considered above are mean diameters. In fact, it has been found that drawing with a constant draw ratio is not completely uniform along the preform but that it has, on a preform whose constituent material has a certain viscosity, the effect of smoothing out the differences in diameter along said preform and that, as an additional consequence, it reduces the diameter variation, for the same preform, along the latter, this being an additional advantage adding to the advantage of reducing the mean diameter variation between preforms. This is because excessively large differences in diameter along a preform may result, on the one hand, in the optical fibers obtained from said preform being scrapped owing to the propagation parameters of said optical fibers not complying with the specifications and, on the other hand, in a risk of the optical fiber breaking during the fiberizing of said preform.

In a second method of implementing the invention, the process for manufacturing optical fiber preforms includes a step of compressing the preform with a compression ratio which remains constant for the same preform and may vary from one preform to another depending on their respective mean diameters so as to reduce the mean diameter variation between preforms. This compression step is similar to the drawing step, but in this case, for each preform, the starting diameter is less than the final diameter.

In the first and second methods of implementing the invention, each preform is either drawn or compressed, and all the preforms manufactured by the process according to the invention are then preferably either all drawn or all compressed, so as to avoid having to carry out, for certain preforms a drawing step or a compression step with draw or compression ratios that are too low, as this is difficult in practice to achieve. This is why the value of the mean draw ratio or mean compression ratio of a set of preforms is advantageously chosen to be high enough to reduce to below a 5% threshold the proportion of preforms for which the draw or compression ratio to be applied is below the minimum ratio that a motor drive system used by the manufacturing process can provide. The draw ratio must not be chosen to be too high, so as not to risk the ends of the preform being excessively deformed because of the weld to the holding rod. Advantageously, the mean draw or compression ratio of a set of preforms is between 8% and 25% of the mean initial length of the preforms in question.

In a third method of implementing the invention, the process for manufacturing optical fiber preforms includes a step of drawing the preform followed or preceded by a step of compressing the preform, the draw and compression ratios of which are different from each other, so that the resulting draw or compression ratio for the preform is non-zero, each remain constant for the same preform and may vary from one preform to the other depending on their respective mean diameters so as to reduce the mean diameter variation between preforms. The successive combination firstly of a drawing step with a constant draw ratio for the same preform followed by a compression step with a constant compression ratio for the same preform, or else firstly the compression step followed by drawing step, makes it possible to obtain a resulting draw ratio, if the draw ratio is greater than the compression ratio, or a resulting compression ratio, if the draw ratio is less than the compression ratio, which are low and otherwise difficult to obtain directly using only a drawing step or only a compression step, respectively. This allows process control with a low resulting draw or a low resulting compression and improves the quality of the preforms thus obtained. The drawing and compression steps are carried out in succession in the course of separate passes if the manufacturing process may have several successive passes of the heat source along the preform. For example, a compression step carried out on a preform with a constant compression ratio of about 16.5% followed by a drawing step carried out on the same preform with a constant draw ratio of about 20% leads to a resulting draw ratio of about 3%. Preferably, the resulting draw or compression ratio is less than each of the draw and compression ratios. The resulting draw or compression ratio is advantageously less than each of the minimum draw and compression ratios that the motor drive system used by the manufacturing process can provide. In this third method of implementation, if the preforms have a small starting diameter and if the draw and compression ratios are high, the drawing step preferably precedes the compression step.

The drawing and the compression do not seem to affect the optical properties of the preforms subjected to said drawing or said compression, provided that the draw and compression ratios do not become excessive.

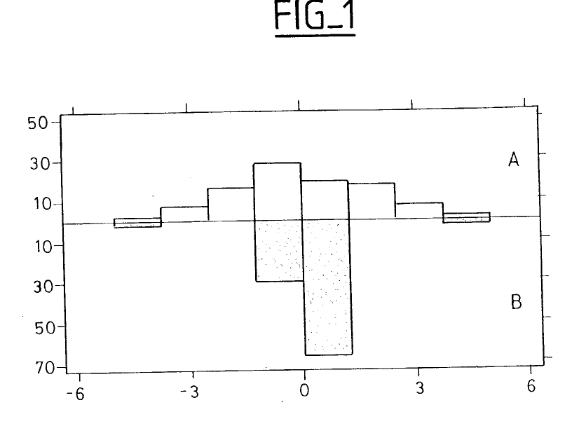

In a preform manufacturing process according to the invention, corresponding to the first method of implementation, that is to say one including only a drawing step, before the drawing step the diameters of a batch of preforms are measured indirectly via their optogeometrical parameters, which are the diameter and the index profile. For example, for a preform of the stepped index type, manufactured by the MCVD process, this corresponds to the core, cladding and tube zones. The drawing step is applied to this batch of preforms, the mean of the final diameters of which, after drawing, is about 90 mm. The final preform diameter actually obtained is recalculated by the drawing device on the basis of the starting diameter and the draw ratio actually applied by the drawing device. This batch of preforms, obtained by the process according to the invention, is represented by curve B in FIGS. 1 and 2. Another batch of preforms is obtained using an identical process, except that this process does not contain the drawing step according to the invention. The mean of the diameters of this test batch of preforms thus obtained is about 100 mm. This test batch of preforms is shown by curve A in FIGS. 1 and 2. Each of the batches corresponding to curves A and B consisted of about sixty preforms.

FIG. 1 shows schematically histograms demonstrating the reduction in the diameter variation between preforms by the use of the manufacturing process according to the first method of implementing the invention. Histogram A, in white, represents the mean diameter variation of the preforms of the test batch, that is to say those obtained without drawing according to the invention. Histogram B, in gray, represents the mean diameter variation of the preforms obtained by the process according to the invention, which includes a drawing step according to the invention. On the x-axis, the value 0 represents the mean of the mean diameters of the preforms of each batch. The values indicated on the x-axis represent the relative difference in percent from these means. Plotted on the y-axis is the percentage per histogram slice. Histogram B appears to be much tighter around the mean value zero than histogram A, which is more spread out. The more spread out the histogram, the greater the diameter variation between preforms. The reduction in spread between histogram A and histogram B is considerable and it reflects the reduction in mean diameter variation between preforms obtained by the use of the manufacturing process according to the invention.

FIG. 2 shows schematically curves obtained from the histograms of FIG. 1 by smoothing, and demonstrating the reduction in the diameter variation between preforms by the use of the manufacturing process according to the invention. Curve A represents the mean diameter variation of the preforms of the test batch. Curve A was obtained by smoothing histogram A. Curve B represents the mean diameter variation of the preforms obtained by the process according to the invention. Curve B was obtained by smoothing histogram B. On the x-axis, the value 0 represents the mean of the mean diameters of the preforms of each batch. The values indicated on the x-axis represent the relative difference in percent from these means. Plotted on the y-axis is the density of the mean preform diameter distribution. Curve B appears to be much tighter around the mean value 0 than curve A, which is more spread out. The more spread out the curve, the greater the mean diameter variation between preforms. The reduction in spread between curve A and curve B is considerable and it reflects the reduction in mean diameter variation between preforms obtained by using the manufacturing process according to the invention. The reduction in standard deviation between curve A and curve B is about 60%.

There is claimed:

1. A process for manufacturing optical fiber preforms that includes a step of drawing the preform with a draw ratio that remains constant for the same preform and may vary from one preform to another depending on their respective mean diameter so as to reduce the variation in mean diameter between preforms.

2. The process for manufacturing optical fiber preforms that includes a step of compressing the preform with a compression ratio that remains constant for the same preform and may vary from one preform to another depending on their respective mean diameter so as to reduce the variation in mean diameter between preforms.

3. The process for manufacturing optical fiber preforms claimed in claim 1, which manufacturing process includes a step of producing a primary preform followed by a step of producing a final preform from the primary preform and wherein the drawing or compression step is a drawing or compression step carried out on the primary preform.

4. The process for manufacturing optical fiber preforms claimed in claim 1, wherein the value of the mean draw ratio or mean compression ratio of a set of preforms is chosen to be high enough to reduce, to below a 5% threshold, the portion of preforms for which the draw or compression ratio to be applied is below the minimum ratio that the motor drive system used by the manufacturing process can provide.

5. The process for manufacturing optical fiber preforms claimed in claim 1, wherein the draw or compression ratio is between 8% and 25%.

6. The process for manufacturing optical fiber preforms that includes a step of drawing the preform followed or preceded by a step of compressing the preform, the draw and compression ratios of which differ from each other, so that the resulting draw or compression ratio for the preform is non-zero, each remain constant for the same preform and may vary from one preform to another depending on their respective mean diameter so as to reduce the variation in mean diameter between preforms.

7. The process for manufacturing optical fiber preforms claimed in claim 6, which manufacturing process includes a step producing a primary preform followed by a step of producing a final preform from the primary preform and wherein the drawing and compression steps are drawing and compression steps carried out on the primary preform, respectively.

8. The process for manufacturing optical fiber preforms claimed in claim 6, wherein the resulting draw or compression ratio is less than each of the draw and compression ratios.

9. The process for manufacturing optical fiber preforms claimed in claim 8, wherein the resulting draw or compression ratio is less than each of the minimum draw and compression ratios that the motor drive system used by the manufacturing process can provide.

10. The process for manufacturing optical fiber preforms claimed in claim 6, wherein the compression step precedes the drawing step.

11. The process for manufacturing optical fiber preforms claimed in claim 1, wherein, during the drawing step and/or during the compression step, the preform is in a horizontal position.

12. The process for manufacturing optical fiber preforms claimed in claim 1, wherein the step of drawing and/or compressing said preform is carried out by heating said preform with a plasma torch.
